(19) United States
(12) Patent Application Publication
(10) Pub. No.: US 2002/0023338 A1
(43) Pub. Date: Feb. 28, 2002

(54) Method for making a magnetoresistive sensor

(76) Inventors: Michael Allen Seigler, Pittsburgh, PA (US); Petrus Antonius van der Heijden, Jefferson Hills, PA (US); Andrew Robert Eckert, Pittsburgh, PA (US)

Correspondence Address: Robert P. Lenart, Pietragallo, Bosick & Gordon, One Oxford Centre, 38th Floor, 301 Grant Street, Pittsburgh, PA, 15219, US

(21) Appl. No.: 09/916,064

(22) Filed: Jul. 26, 2001

Related U.S. Application Data
(60) Provisional application No. 60/221,493, filed on Jul. 27, 2000.

(51) Int. Cl. H04R 31/00; G11B 5/127

(52) U.S. Cl. 29/603.15; 29/603.07; 29/603.12; 29/603.13

(57) ABSTRACT

A method for making a magnetic sensor for a disk drive read head comprises the steps of fabricating a giant magnetoresistive stack on a surface of a layer of bottom shield material, the giant magnetoresistive stack including an etch stop layer positioned on an end of the giant magnetoresistive stack opposite the surface and a buffer layer positioned on the etch stop layer, depositing an insulating material on the giant magnetoresistive stack and the surface of the layer of bottom shield material, planarizing the insulating material to form a top surface of the insulating material lying in a plane adjacent to or passing through the buffer layer, vacuum etching the buffer layer, and depositing a top shield layer on the insulating material and the giant magnetoresistive stack. A self-planarizing material can also be deposited on the insulating material. If the giant magnetoresistive stack is fabricated without the buffer layer and etch stop layer, then the self planarizing material and the insulating material can be planarized using a vacuum etch process until a surface of the insulating material lies in a plane adjacent to an end of the giant magnetoresistive stack. Alternatively, the self-planarizing material can be applied without the insulating material, and then planarized using a vacuum etch process until a surface of the self-planarizing material lies in a plane adjacent to an end of the giant magnetoresistive stack. Magnetic sensors made in accordance with the above methods are also included.

### CROSS REFERENCE TO RELATED APPLICATION

This application claims the benefit of U.S. Provisional Application No. 60/221,493, filed Jul. 27, 2000.

### BACKGROUND OF THE INVENTION

This invention relates to sensors for use in detecting magnetically encoded information in magnetic storage media, and more particularly, to a method for making such sensors.

Devices utilizing the giant magnetoresistance (GMR) effect have utility as magnetic sensors, especially in read heads used in magnetic disc storage systems. The GMR effect is observed in thin, electrically conductive multi-layer systems having magnetic layers. Magnetic sensors utilizing the GMR effect are frequently referred to as “spin valve” sensors.

A spin valve sensor is typically a sandwiched structure including two ferromagnetic layers separated by a thin non-ferromagnetic layer. One of the ferromagnetic layers is called the “pinned layer” because it is magnetically pinned or oriented in a fixed and unchanging direction. A common method of maintaining the magnetic orientation of the pinned layer is through anti-ferromagnetic exchange coupling utilizing a proximate, i.e. adjacent or nearby, anti-ferromagnetic layer, commonly referred to as the “pinning layer.” The other ferromagnetic layer is called the “free” or “unpinned” layer because its magnetization can rotate in response to the presence of external magnetic fields.

The benefits of spin valve sensors result from a large difference in electrical conductivity exhibited by the devices depending on the relative alignment between the magnetizations of the GMR element ferromagnetic layers. In order for antiferromagnetically pinned spin valve sensors to function effectively, a sufficient pinning field from the pinning layer is required to keep the pinned ferromagnetic layer's magnetization unchanged during operation. Various anti-ferromagnetic materials, such as PtMn, NiMn, FeMn, NiO, IrMn, PtPdMn, CrMnPt, RuRhMn, and TbCo, have been used or proposed as antiferromagnetic pinning layers for spin valve sensors. GMR sensors can be used to sense information encoded in magnetic storage media. In operation, a sense current is passed through a GMR stack. The presence of a magnetic field in the storage media adjacent to the sensor changes the resistance of a GMR stack. A resulting change in voltage drop across the GMR stack due to the change of the resistance of the GMR stack can be measured and used to recover magnetically stored information.

These sensors typically comprise a stack of thin sheets of a ferromagnetic alloy, such as NiFe (Permalloy), magnetized along an axis of low coercivity. The sheets are usually mounted in the head so that their magnetic axes are transverse to the direction of disc rotation and parallel to the plane of the disc. The magnetic flux from the disc causes rotation of the magnetization vector in at least one of the sheets, which in turn causes a change in resistivity of the stack.

A magnetic sensor for use in a disk drive can include a first shield, a second shield, and a GMR stack located between the first shield and the second shield. A permanent magnet can be located adjacent to the GMR stack to provide a bias magnetic field. For operation of the sensor, a sense current is caused to flow through the GMR stack. As resistance of the GMR stack changes, the voltage across the GMR stack changes. This is used to produce an output voltage.

The output voltage is affected by various characteristics of the sensor. The sense current can flow through the stack in a direction that is perpendicular to the planes of the stack strips, i.e. current-perpendicular-to-plane component or CPP, or the sense current can flow through the stack in a direction that is parallel to the planes of the stack strips, i.e. current-in-plane or CIP. The CPP operating mode can result in higher output voltage than the CIP operating mode. The higher the output voltage, the greater the precision and sensitivity of the read sensor in sensing magnetic fields from the magnetic medium. Therefore, it is desirable to maximize the output voltage of the read sensor.

GMR sensors typically have a relatively low resistance. There have been three primary approaches to overcoming the problem of low sensor resistance of current perpendicular to the plane (CPP) giant magnetoresistance (GMR) sensors and allowing the GMR to be measured. One approach uses superconducting contacts and measures the GMR at low temperatures. A second approach involves making the GMR stack very thick to raise its resistance. A third approach involves making a very small GMR stack to increase its resistance. The first two approaches are not practical when it comes to the making the CPP-GMR sensor for use in a magnetic recording head. The disk drive cannot run at very low temperatures nor can the sensor be more than 100's of nanometers thick. The two main problems with the third approach relate to manufacturing the small devices and achieving a low contact resistance. The contact resistance is significant for small devices since the contact resistance varies as the inverse of the sensor area.

Contacts for CPP sensors have been made using two different methods. The first method is to use reactive ion etching (RIE) to etch a via down to a surface of the GMR stack through an insulator material and stop on the GMR stack. The second method is to use chemical mechanical polishing (CMP) to planarize the insulator down to the GMR stack. A lead or conductive shield makes electrical contact with the end of the GMR stack. When etching a via to make contact to the sensor, it becomes difficult to ensure that the exposed surface of the underlying GMR stack is cleaned to the level necessary for low contact resistance.

CMP is a wet chemistry process that subjects the sensor to chemicals and physical polishing by a polishing pad. One of the main difficulties in using the CMP processing relates to stopping the process on a desired film stack. When using CMP to planarize a GMR stack in a magnetic recording read head, the stopping control becomes critical. Stopping of the planarization will control the shield-to-shield spacing, the sensor resistance and possibly the number of ferromagnetic/non-magnetic bilayers that are left in the sensor. At design points greater than 100 Gbit/in², the shield-to-shield spacing needs to be less than 800 Å, so control of this stopping point is critical.

A typical CMP planarization process for use in fabricating a bottom shield of a disk drive read head starts with a magnetoresistive element positioned on a bottom shield. The magnetoresistive element is usually defined by sputter depositing the magnetoresistive film, using lithography to define a mask and ion milling to etch the pattern into the magnetoresistive film. A thick insulator material is deposited on the bottom shield and the magnetoresistive element. This is typically accomplished using sputter deposited alumina. Then the structure is planarized by using CMP, to remove a portion of the insulating material, and possibly, a portion of the magnetoresistive element.

The process can be monitored by stopping the CMP machine and using ellipsometry to measure the remaining insulator thickness. Ellipsometry monitoring along with process timing is what is normally used to stop the process. Special chemistries can also be used, such that one material may etch faster than the other. This helps when trying to stop at a certain level in a magnetoresistive element, but it usually causes a step height difference between the two materials. Even when special chemistries are used, the stopping point is still determined by time and insulator thickness measurements. There are also some various CMP endpoint schemes such as those that monitor the CMP motor torque, pad temperature, and the slurry composition, but none of these have been proven to work as well as will be needed in the CPP head fabrication process.

With a CMP process, it is difficult to determine exactly when to stop. The material removal rates are usually fast enough such that the time window in which the CMP should be stopped is not very large. In addition, wafer bow across a six-inch wafer can have a large effect on the uniformity of the device. If a thick insulator (1 μm thicker than the structure to be planarized) is deposited in order to planarize a given structure, and even if the CMP uniformity is good (3σ=5%), stopping within 500 Å of a given point across the wafer is still difficult.

There is a need for a method for making a magnetic sensor that provides an improved planarization process so a low resistance contact can be made to the GMR stack.

### SUMMARY OF THE INVENTION

A method for making a magnetic sensor for a disk drive read head comprises the steps of fabricating a giant magnetoresistive stack on a surface of a layer of bottom shield material, the giant magnetoresistive stack including an etch stop layer positioned on an end of the giant magnetoresistive stack opposite the surface and a buffer layer positioned on the etch stop layer, depositing an insulating material on the giant magnetoresistive stack and the surface of the layer of bottom shield material, planarizing the insulating material to form a top surface of the insulating material lying in a plane adjacent to or passing through the buffer layer, etching the buffer layer, and depositing a top shield layer on the insulating material and the giant magnetoresistive stack, the top shield layer making electrical contact with the giant magnetoresistive stack. The planarizing step can be performed using chemical machining polishing or etching.

An alternative embodiment of the invention encompasses a method for manufacturing a magnetic sensor for a disk drive read head comprising the steps of fabricating a giant magnetoresistive stack on a surface of a layer of bottom shield material, depositing an insulating material on the giant magnetoresistive stack and the surface of the layer of bottom shield material, depositing a self-planarizing material on the insulating material, planarizing the self planarizing material and the insulating material using a vacuum etch process that removes the self planarizing material and the insulating material at the same rate until a surface of the insulating material lies in a plane adjacent to an end of the giant magnetoresistive stack, and depositing a top shield layer on the insulating material and the giant magnetoresistive stack.

Another alternative embodiment of the invention encompasses a method for making a magnetic sensor for a disk drive read head comprises the steps of fabricating a giant magnetoresistive stack on a surface of a layer of bottom shield material, the giant magnetoresistive stack including an etch stop layer positioned on an end of the giant magnetoresistive stack opposite the surface and a buffer layer positioned on the etch stop layer, depositing an insulating material on the giant magnetoresistive stack and the surface of the layer of bottom shield material, depositing a self-planarizing material on the insulating material planarizing the insulating material using chemical machining polishing to form a top surface of the insulating material lying in a plane adjacent to or passing through the buffer layer, etching the buffer layer, and depositing a top shield layer on the insulating material and the giant magnetoresistive stack, the top shield layer making electrical contact with the giant magnetoresistive stack.

Another alternative embodiment of the invention encompasses a method for manufacturing a magnetic sensor for a disk drive read head comprising the steps of fabricating a giant magnetoresistive stack on a surface of a layer of bottom shield material, depositing a self planarizing material on the giant magnetoresistive stack and the surface of the layer of bottom shield material, planarizing the self planarizing material using a vacuum etch process until a surface of the self planarizing material lies in a plane adjacent to an end of the giant magnetoresistive stack, and depositing a top shield layer on the self planarizing material and the giant magnetoresistive stack.

The invention further encompasses sensors constructed in accordance with the above methods.

### BRIEF DESCRIPTION OF THE DRAWINGS

FIG. 1 is a pictorial representation of a disk drive that can use magnetic sensors constructed in accordance with this invention;

FIG. 2 is a cross-sectional view of a portion of a magnetic sensor constructed in accordance with this invention;

FIGS. 3 through 11 illustrate the steps of making a magnetic sensor in accordance with a first embodiment of this invention; and

FIGS. 12 through 14 illustrate the steps of making a magnetic sensor in accordance with another embodiment of this invention.

### DESCRIPTION OF THE PREFERRED EMBODIMENTS

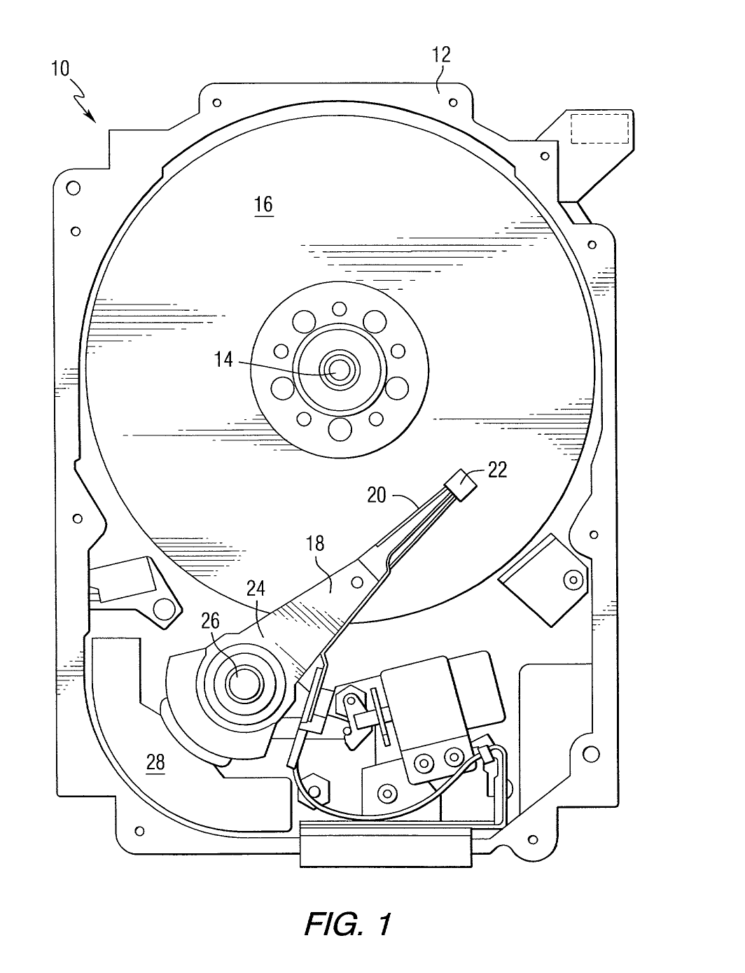

The present invention provides a method for making improved magnetic sensors for use with magnetic recording media. Sensors constructed in accordance with the invention are particularly suitable for use within a disc drive for computers. FIG. 1 is a pictorial representation of a typical disk drive 10 that can utilize magnetic sensors constructed in accordance with this invention. The disk drive includes a housing 12 (with the upper portion removed and the lower portion visible in this view) sized and configured to contain the various components of the disk drive. The disk drive includes a spindle motor 14 for rotating at least one magnetic storage medium 16 within the housing, in this case a magnetic disk. At least one arm 18 is contained within the housing 12, with each arm 18 having a first end 20 with a recording and/or reading head or slider 22, and a second end 24 pivotally mounted on a shaft by a bearing 26. An actuator motor 28 is located at the arm's second end 24, for pivoting the arm 18 to position the head 22 over a desired sector of the disk 16. The actuator motor 28 is regulated by a controller that is not shown in this view and is well known in the art.

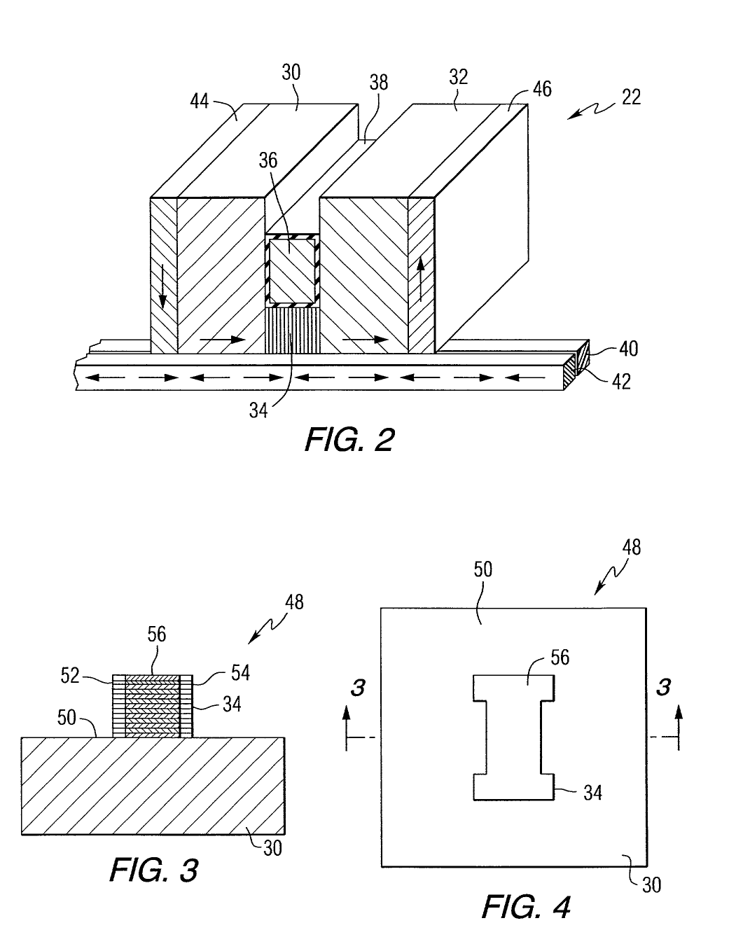

FIG. 2 is a cross-sectional view of a portion of a slider 22 having a magnetic sensor constructed in accordance with this invention. The slider includes first and second conductive shields 30 and 32 positioned on opposite sides of a giant magnetoresistive stack 34. A permanent magnet 36 is encased in an insulating material 38 and positioned above the giant magnetoresistive stack. The slider is configured to fly adjacent to a magnet recording medium 16 having a plurality of tracks, illustrated by tracks 40, 42. The tracks contain magnetic domains capable of storing digital information according to the polarity of magnetization thereof. The magnetic domains are illustrated by arrows in the tracks. Conductors 44 and 46 are positioned adjacent to shields 30 and 32 respectively and are used to supply a constant current I that flows through the shields and the GMR stack in a current perpendicular to the plane direction. Conductors 44 and 46 have a lower electrical resistance than the shields. When the GMR stack is subjected to an external magnetic field, the resistance of the stack changes, thereby changing the voltage across the stack. The stack voltage is then used to produce an output voltage.

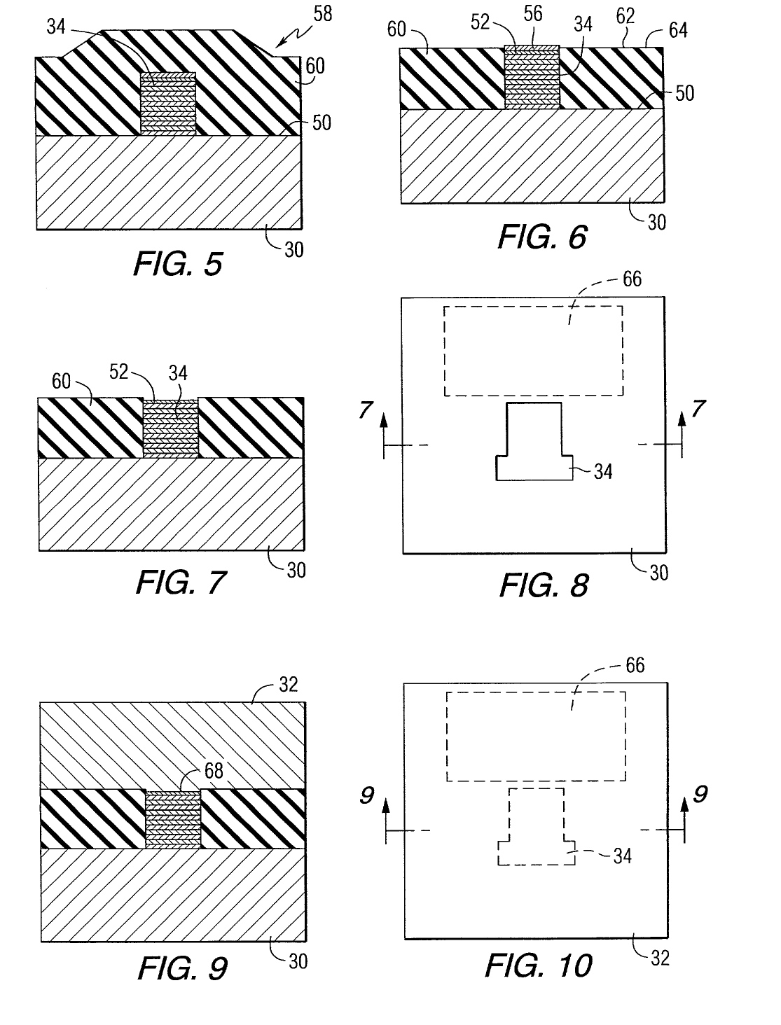

FIGS. 3 through 11 illustrate the steps used to make a magnetic sensor in accordance with a first preferred embodiment of the method of the invention. FIG. 3 is a cross-sectional view, and FIG. 4 is a top plan view, of an intermediate structure 48 formed when practicing the invention. Structure 48 includes the giant magnetoresistive stack 34 mounted on a surface 50 of the shield 30. To form this structure, layers of the giant magnetoresistive stack are typically deposited on the entire surface 50 of the shield and etched to leave the portion of the giant magnetoresistive stack illustrated in FIGS. 3 and 4. The giant magnetoresistive stack 34 includes an etch stop layer 52 positioned at an end 54 of the giant magnetoresistive stack 34 opposite the shield. A buffer layer 56 is positioned on the etch stop layer 52.

FIG. 5 is a cross-sectional view of another intermediate structure 58 formed when practicing the invention. FIG. 5 includes a layer of insulating material 60 that has been deposited on the giant magnetoresistive stack 34 and the surface 50 of the shield 30. It has been found empirically that in order to achieve low contact resistance to a CPP sensor, the end of the stack needs to be at least partially planarized.

The structure of FIG. 5 is then planarized using chemical mechanical polishing (CMP) so that the top surface 62 of the insulating material lies in a plane 64 that passes adjacent to, or through the buffer layer 56 on the top of the giant magnetoresistive stack 34 as shown in FIG. 6.

A reactive ion etch can achieve this, but other chemically enhanced etches can also achieve this. The remaining buffer layer is then etched away to produce the structure shown in FIG. 7. Various types of etching can be used as long as the etch rate of the buffer layer is greater than the etch rate of the stop layer. Reactive ion etching can achieve this, as can chemically enhanced etches. If the materials are chosen properly even a purely physical etch may work, for example, Cu as the buffer layer and Ta as the stop layer. FIG. 8 is a top plane view of the structure of FIG. 7 in which a permanent magnet material layer 66 has been deposited adjacent to the GMR stack 34. The permanent magnet material layer is embedded in the structure in accordance with know processes that do not form a part of this invention.

FIG. 9 is a cross-sectional view of the sensor after shield 32 has been added. Shield 32 makes contact with the GMR stack at surface 68.

The above embodiment of the invention uses a combination CMP) and vacuum etch planarization process. With this invention, stopping of the CMP process is less critical, since the final planarization is performed using a vacuum etch process that is much more controllable. The planarization capability of CMP is utilized along with the etch stop capability of a reactive ion etch.

The process steps for the combination CMP and vacuum process can now be described in more detail. The process starts with a patterned bottom shield on a wafer. The wafer material can be, for example AlTiC or Si. The bottom shield material can be, for example NiFe, NiFeCu, or NiCoFe. NiFe is currently the most widely used material. A GMR material stack is fabricated on the surface of the bottom shield using known processes, such as by lithography and ion milling. An etch stop layer is positioned at an end of the GMR stack opposite the surface of the bottom shield. A buffer layer positioned on the etch stop layer at the top of the GMR stack should be a material that can be reactively etched in a chemistry that does not etch the etch stop layer. For example, the buffer layer could be W, Ta, or SiN, which etches using reactive ion etching and fluorine based chemistries and the stop layer could be Au, NiFe, CoFe, NiCoFe or Cu, which are not etched using reactive ion etching and fluorine based chemistries.

A thick insulator is deposited on the stack and the surface of the wafer, as is done in a typical CMP process. The thickness of the insulator on the surface of the wafer should be greater that the height of the GMR stack. The insulator material can be, for example Al₂O₃, AlN, AlON, SiO₂, SiN or SiON, with Al₂O₃ being the currently preferred material. A known CMP process is then used to planarize the wafer. The film thickness, and CMP chemistry and process, should be chosen such that the entire wafer can be chemical mechanical polished into the buffer layer. The buffer layer should be thicker than the CMP variation across the wafer plus the error in stopping the CMP process. The buffer layer must be exposed by the CMP, but the stopping layer should not be exposed.

Next, a vacuum process is used to etch away the remaining buffer layer. This etch process could be a reactive ion etch, a wet chemical etch, or any other type of etch that can etch this material but be stopped by the stop layer. This etch process can be run long enough to ensure that the buffer layer is completely removed across the top of the GMR stack. This ensures that the top of the GMR stack is at the same point regardless of the CMP uniformity or the etch process. The etch stop layer can either remain in the sensor, or be removed. For example if the etch stop layer has sufficient electrical conductivity and is otherwise compatible with the desired end sensor configuration, it may be possible to leave it in the sensor such that the top shield can make contact with it. In order for the etch stop material to be left in the structure, it must be electrically conductive and preferably very conductive, such as Cu, Ag or Au. Alternatively, an ion mill or other etch process could be used to remove the stop layer if it cannot remain in the stack.

This process results in nearly perfect stopping control. The buffer layer materials listed above can reactively etch at rates of 100's of angstroms per minute, while the stopping layer films such as NiFe are not etched a measurable amount. The wafer planarization is not perfect. There will be some variation across the wafer depending on the CMP uniformity. Whether the GMR stack is slightly recessed, protruding, or perfectly level with the insulator can be controlled in part by the slurry chemistry used during the CMP process. The GMR should not protrude to the point where the entire stopping layer is sticking above the insulating layers. This will cause the stack below the stopping layer to be exposed to the etch process, if it is a non-directional process. In general, the GMR layer should not be recessed further than it is wide, so that cleaning agents can get down into the via.

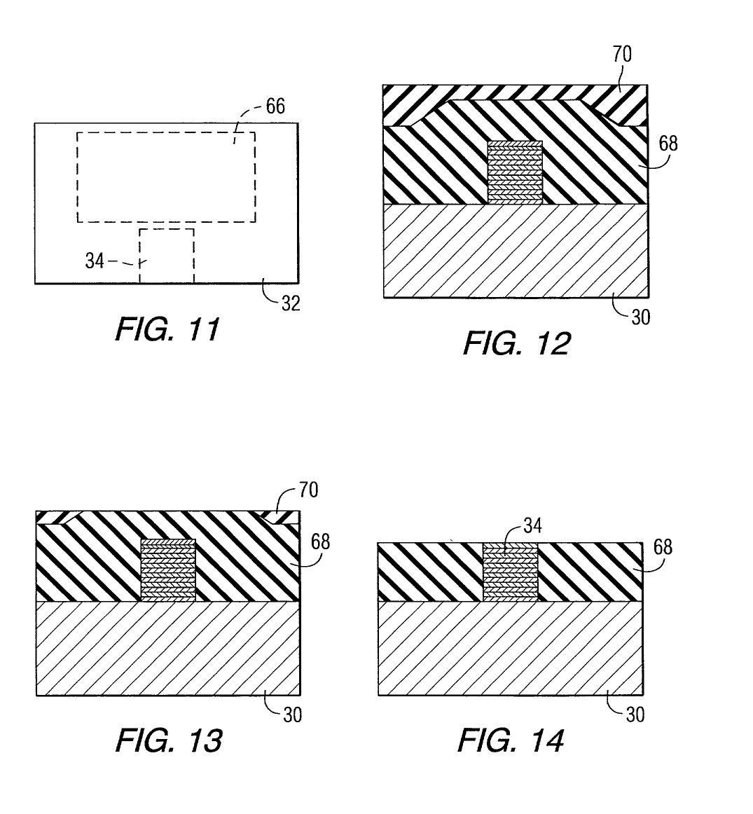

An alternative embodiment of the invention solves the CMP issues by using an all-vacuum process. The steps used in the vacuum planarization process are illustrated in FIGS. 12 through 14. The process starts with a layer of bottom shield material having a GMR material stack that has been fabricated as previously described, for example by lithography and ion milling. A thick insulator, such as Al₂O₃ (alumina) 68 is deposited, as shown in FIG. 12. The insulator layer needs to be thicker than a desired thickness after planarizing. A self-planarizing material 70, such as a spin on glass/dielectric or a standard photo resist (PR), is applied to the layer of bottom shield material. A photo resist will be referred to throughout the rest of this description. The structure is etched using a process that removes the insulator and the PR at the same rate. For example, materials that could be removed at the same rate include Al₂0₃, SiO₂, or SiN if the etch process is chosen properly. Al₂0₃ and a photo resist could be used if the etch process is an ion mill process using the combination of Argon and CHF3 as the process gases. FIG. 13 is a cross-sectional view of the structure after it has been partially planarized.

An endpoint scheme such as optical endpoint detection or secondary ion mass endpoint detection can be used to indicate that the etch has reached the GMR material stack, to achieve the structure shown in FIG. 14. This is very accurate and can be stopped within 10's of angstroms of the desired point. Depending on the etch process used and the amount of over etch used, the topography can vary from the material stack protruding, to the material stack being recessed. With the etch process referred to above, the material stack can vary from being recessed to protruding if the material stack is capped with a material such as NiFe.

The deposition of the insulator 68 could be skipped and just the self-planarizing material used if desired. This would allow for more freedom in choosing the etch process, but it would require that this material be left behind in the device being built. Whether this is acceptable or not would depend on the device being built.

In another alternative embodiment of the invention a method for making a magnetic sensor for a disk drive read head comprises the steps of fabricating a giant magnetoresistive stack on a surface of a layer of bottom shield material, the giant magnetoresistive stack including an etch stop layer positioned on an end of the giant magnetoresistive stack opposite the surface and a buffer layer positioned on the etch stop layer, depositing an insulating material on the giant magnetoresistive stack and the surface of the layer of bottom shield material, depositing a self-planarizing material on the insulating material planarizing the insulating material using chemical machining polishing to form a top surface of the insulating material lying in a plane adjacent to or passing through the buffer layer, etching the buffer layer, and depositing a top shield layer on the insulating material and the giant magnetoresistive stack, the top shield layer making electrical contact with the giant magnetoresistive stack.

This invention applies several planarizing techniques for a CPP device and, in a preferred embodiment, uses an ion milling etch back process with endpoint detection. The invention employs vacuum planarization techniques that allow for good stopping control and low contact resistance. While the present invention has been described in terms of what are at present believed to be its preferred embodiments, it will be apparent to those skilled in the art that various modifications to these disclosed embodiments can be made without departing from the invention as defined by the following claims.

What is claimed is:

1. A method for making a magnetic sensor for a disk drive read head, the method comprising the steps of:
fabricating a giant magnetoresistive stack on a surface of a layer of bottom shield material, the giant magnetoresistive stack including an etch stop layer positioned on an end of the giant magnetoresistive stack opposite the surface of the wafer and a buffer layer positioned on the etch stop layer;
depositing an insulating material on the giant magnetoresistive stack and the surface of the layer of bottom shield material;
planarizing the insulating material to form a top surface of the insulating material lying in a plane adjacent to or passing through the buffer layer;
etching the buffer layer; and
depositing a top shield layer on the insulating material and the giant magnetoresistive stack, the top shield layer making electrical contact with the giant magnetoresistive stack.

2. A method for making a magnetic sensor for a disk drive read head according to claim 1, wherein the step of planarizing the insulating material is performed using chemical machining polishing.

3. A method for making a magnetic sensor for a disk drive read head according to claim 1, wherein the step of planarizing the insulating material is performed using a vacuum etch process.

3. A method for making a magnetic sensor for a disk drive read head according to claim 1, the method further comprising the steps of:
etching the etch stop layer prior to the step of depositing a top shield layer on the insulating material and the giant magnetoresistive stack.

4. A method for making a magnetic sensor for a disk drive read head according to claim 1, wherein:
the insulating material comprises a material selected from the group of Al₂O₃,AlN, AlON, SiO₂, SiN and SiON.

5. A method for making a magnetic sensor for a disk drive read head according to claim 1, wherein:
the etch stop layer comprises a material selected from the group of Au, Cu, NiFe, CoFe, NiCoFe, Al₂O₃, and Ta.

6. A method for making a magnetic sensor for a disk drive read head according to claim 1, wherein:
the buffer layer comprises a material selected from the group of Ta, W, Ti, Cu, SiO₂ and SiN.

7. A magnetic sensor made in accordance with the method of claim 1.

8. A method for making a magnetic sensor for a disk drive read head, the method comprising the steps of:
fabricating a giant magnetoresistive stack on a surface of a layer of bottom shield material;
depositing an insulating material on the giant magnetoresistive stack on the surface of the layer of bottom shield material;
depositing a self-planarizing material on the insulating material;
planarizing the self planarizing material and the insulating material using a vacuum etch process that removes the self planarizing material and the insulating material at the same rate until a surface of the insulating material lies in a plane adjacent to an end of the giant magnetoresistive stack; and
deposing a top shield layer on the insulating material and the giant magnetoresistive stack.

9. A method for making a magnetic sensor for a disk drive read head according to claim 8, wherein:
the insulating material comprises a material selected form the group of alumina, SiO₂, SiN.

10. A method for making a magnetic sensor for a disk drive read head according to claim 8, wherein:
the self-planarizing material comprises a material selected from the group of a spin on glass and a photo resist.

11. A magnetic sensor made in accordance with the method of claim 8.

12. A method for making a magnetic sensor for a disk drive read head, the method comprising the steps of:
fabricating a giant magnetoresistive stack on a surface of a layer of bottom shield material, the giant magnetoresistive stack including an etch stop layer positioned on an end of the giant magnetoresistive stack opposite the surface and a buffer layer positioned on the etch stop layer;
depositing an insulating material on the giant magnetoresistive stack and the surface of the layer of bottom shield material;
depositing a self-planarizing material on the insulating material;
planarizing the self-planarizing material and the insulating material using chemical machining polishing to form a top surface of the insulating material lying in a plane adjacent to or passing through the buffer layer;
etching the buffer layer; and
depositing a top shield layer on the insulating material and the giant magnetoresistive stack, the top shield layer making electrical contact with the giant magnetoresistive stack.

13. A method for making a magnetic sensor for a disk drive read head according to claim 12, the method further comprising the steps of:
etching the etch stop layer prior to the step of depositing a top shield layer on the insulating material and the giant magnetoresistive stack.

14. A method for making a magnetic sensor for a disk drive read head according to claim 12, wherein:
the insulating material comprises a material selected from the group of Al₂O₃, AlN, AlON, SiO₂, SiN and SiON.

15. A method for making a magnetic sensor for a disk drive read head according to claim 12, wherein:
the etch stop layer comprises a material selected from the group of Au, Cu, NiFe, CoFe, NiCoFe, Al₂O₃, and Ta.

16. A method for making a magnetic sensor for a disk drive read head according to claim 12, wherein:
the buffer layer comprises a material selected from the group of Ta, W, Ti, Cu, SiO₂ and SiN.

17. A magnetic sensor made in accordance with the method of claim 12.

18. A method for making a magnetic sensor for a disk drive read head, the method comprising the steps of:
fabricating a giant magnetoresistive stack on a surface of a layer of bottom shield material;
depositing a self-planarizing material on the giant magnetoresistive stack on the surface of the layer of bottom shield material;
planarizing the self planarizing material using a vacuum etch process that removes the self planarizing material until a surface of the self planarizing material lies in a plane adjacent to an end of the giant magnetoresistive stack; and
depositing a top shield layer on the self-planarizing material and the giant magnetoresistive stack.

19. A method for making a magnetic sensor for a disk drive read head according to claim 18, wherein:
the self-planarizing material comprises a material selected from the group of a spin on glass and a photo resist.

20. A magnetic sensor made in accordance with the method of claim 18.
